(19) United States
(12) Patent Application Publication
(10) Pub. No.: US 2020/0218365 A1
(43) Pub. Date: Jul. 9, 2020

(54) Method of Motion Capture

(71) Applicant: Red Pill Lab Limited, Central (HK)

(72) Inventors: Dobromir Todorov, Central (HK); Yi-Chi Huang, Central (HK); Ting-Chieh Lin, New Taipei City (TW); Chien-Hung Shih, Central (HK)

(21) Appl. No.: 16/731,382

(22) Filed: Dec. 31, 2019

(30) Foreign Application Priority Data
Jan. 4, 2019 (TW) 108100399

(51) Int. Cl. G06F 3/03; G06F 3/01; G06T 7/73

(52) U.S. Cl. CPC G06F 3/0325; G06F 3/011; G06T 2207/20044; G06T 2207/20084; G06T 2207/30196; G06T 7/73

(57) ABSTRACT

A method of motion capture includes: by multiple positioning devices located on a user, receiving scanning signals emitted by signal emitting devices to obtain detected coordinates, determining angular information, and generating and transmitting to a processor position signals that contain the angular information and the detected coordinates of the positioning devices; by the processor based on the position signals and data of a skeleton related to the user, determining estimated coordinates of a position of a body portion of the user; and generating an image of a virtual object based on the position signals, the estimated coordinates, the data of the skeleton related to the user and data of a skeleton related to a virtual object, and controlling a display to display the image.

### CROSS-REFERENCE TO RELATED APPLICATION

This application claims priority to Taiwanese Invention Patent Application No. 108100399 filed Jan. 4, 2019, the disclosure of which is hereby incorporated by reference in its entirety.

### FIELD

The disclosure relates to a method of motion capture, and more particularly to a method of motion capture with a reduced hardware cost and shortened time for data processing.

### BACKGROUND

In a conventional method of motion capture, an image capturing device (e.g., an infrared optical sensor) is utilized to trace markers (e.g., more than 40 reflective markers or magnetic markers) attached to a user so as to obtain coordinates of posit ions of body portions (e.g., joints) of the user for establishing a skeleton of a virtual object that is related to the user. The image capturing device may record coordinates of positions of the body portions of the user as the user performs a target action. Animation of the virtual object performing the target action would be made based on the skeleton of the virtual object thus established and the coordinates thus recorded.

To record the exact motions of the user for entertainment applications such as in gaming and filmmaking, a large number of the image capturing devices and the markers are required. Moreover, special software for processing collected data is also required when the infrared optical sensors are utilized to serve as the image capturing devices. Consequently, approaches to reducing hardware cost and software cost of the conventional method of motion capture are in demand.

### SUMMARY

Therefore, an object of the disclosure is to provide a method of motion capture that can alleviate at least one of the drawbacks of the prior art.

According to the disclosure, the method of motion capture is adapted to record a posture of a user in a predefined space and translate the recorded posture to a virtual object. The method is to be implemented by a system that includes a processor, a display device, two signal emitting devices located at respective predetermined positions, and six positioning devices respectively located on a head, a waist, a left hand, a right hand, a left foot and a right foot of the user. The method includes steps of:

(A) emitting, by one of the signal emitting devices, a two-dimensional (2D) scanning signal along a predetermined direction to scan the predefined space, and emitting, by another of the signal emitting devices, another 2D scanning signal along another predetermined direction to scan the predefined space;

(B) by each of the positioning devices at an instant during performance of a target action by the user, receiving the 2D scanning signals emitted from the signal emitting devices so as to obtain detected spatial coordinates of a current position of the positioning device, determining angular information of an orientation of the positioning device, generating a position signal that contains the angular information of the orientation of the positioning device, and that contains the detected spatial coordinates of the current position of the positioning device, and transmitting the position signal to the processor based on wireless communication techniques;

(C) determining, by the processor based on the position signals respectively received from the positioning devices and based on data of a skeleton related to the user, estimated spatial coordinates of a current position of a specific body portion of the user by using one of a machine learning model and a position estimating model that matches the skeleton related to the user; and

(D) by the processor, generating an image of the virtual object at the instant during performance of the target action based on the position signals, the estimated spatial coordinates, the data of the skeleton related to the user, and data of a skeleton related to the virtual object, and controlling the display device to display the image of the virtual object at the instant during performance of the target action.

### BRIEF DESCRIPTION OF THE DRAWINGS

Other features and advantages of the disclosure will become apparent in the following detailed description of the embodiments with reference to the accompanying drawings, of which:

FIG. 1 is a block diagram illustrating an embodiment of a system that is utilized to implement a method of motion capture according to the disclosure;

FIG. 2 is a perspective schematic diagram illustrating an embodiment of arrangement of two signal emitting devices and six positioning devices of the system according to the disclosure;

FIG. 3 is a block diagram illustrating an embodiment of each of the positioning devices according to the disclosure;

FIG. 4 is a flow chart illustrating an embodiment of a procedural flow of the method of motion capture according to the disclosure; and

FIG. 5 is a schematic diagram illustrating an embodiment of an image for preview according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

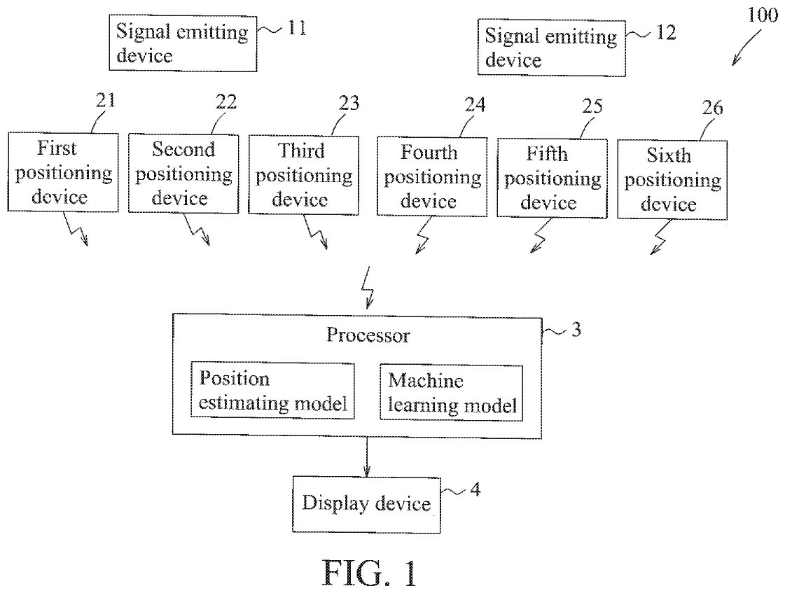

Referring to FIG. 1, an embodiment of a system 100 that is utilized to implement a method of motion capture according to the disclosure is illustrated.

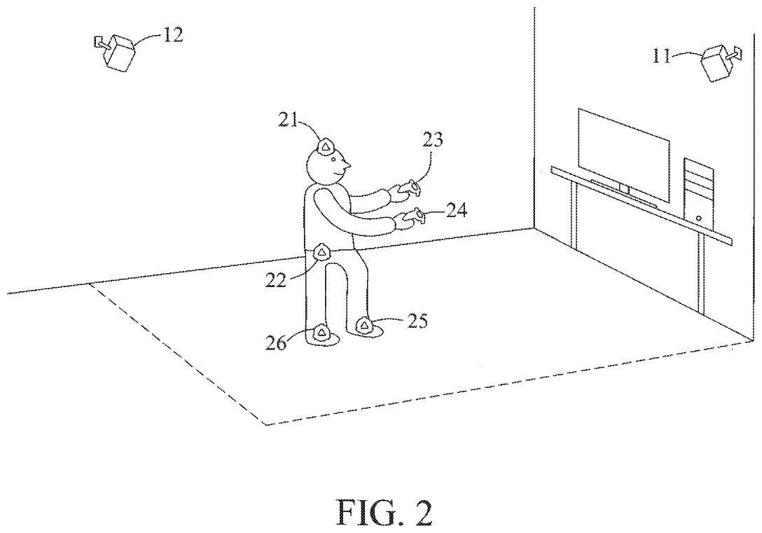

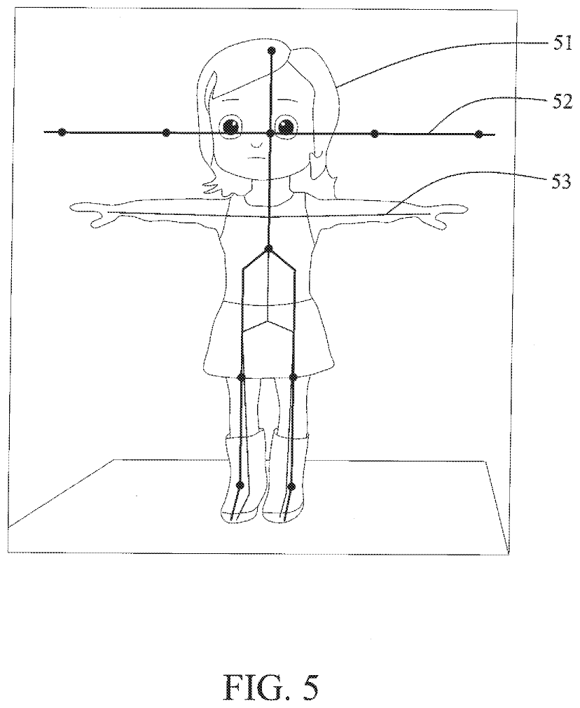

Referring to FIG. 2, the method of motion capture according to the disclosure is adapted to record a posture of a user in a predefined space and to translate the recorded posture to a virtual object, so that the virtual object can mimic movement of the user. In this embodiment, the predefined space is a room that has a volume of 3 to 5 m³, but is not limited thereto and may vary in other embodiments. In this embodiment, the virtual object is a cartoon character (see FIG. 5), but may be an animal, a robot, or any animated character with a head and four limbs in other embodiments.

The system 100 includes a processor 3, a display device 4, two signal emitting devices 11 and 12 located at respective predetermined positions, and six positioning devices 21 to 26, namely first to sixth positioning devices 21, 26 respectively located on the head, the waist, the left hand, the right hand, the left foot and the right foot of the user. It should be noted that the signal emitting devices 11 and 12 are respectively located on two terminals or terminations of a diagonal of the room, and are opposite to each other.

Each of the signal emitting devices 11 and 12 is configured to emit a two-dimensional (2D) scanning signal, and may be implemented by an infrared (IR) emitter that emits IR signal serving as the 2D scanning signal or a laser scanner that emits laser light serving as the 2D scanning signal. However, implementations of the signal emitting devices 11 and 12 are not limited to the disclosure herein and may vary in other embodiments.

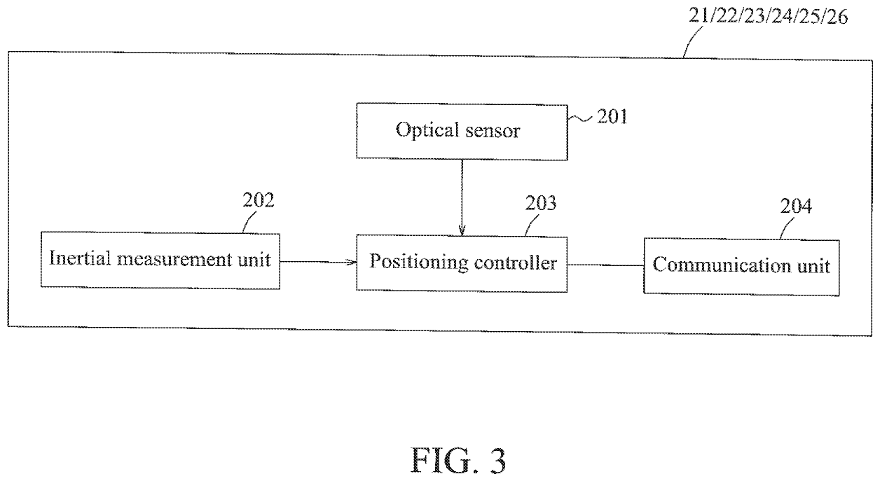

Referring to FIG. 3, an embodiment of each of the first to the sixth positioning devices 21 to 26 is illustrated. Each of the first to the sixth positioning devices 21 to 26 includes an optical sensor 201, an inertial measurement unit (IMU) 202, a communication unit 204, and a positioning controller 203 that is electrically connected to the optical sensor 201, the IMU 202 and the communication unit 204. The optical sensor 201 may be implemented by an IR sensor when the signal emitting devices 11 and 12 are IR emitters, and may be implemented by a laser sensor when the signal emitting devices 11 and 12 are laser scanners. The communication unit 204 may be implemented by a short-range wireless transmitter. The positioning controller 203 may be implemented by any circuit configurable/programmable in a software manner and/or hardware manner to implement functionalities discussed in this disclosure. However, it should be noted that implementations of the first to the sixth positioning devices 21 to 26 are not limited to the disclosure herein and may vary in other embodiments. For the sake of simplicity, the first to the sixth positioning devices 21 to 26 will at times be referred to simply as “the positioning devices 21-26” throughout this disclosure since they are composed of the same components and serve the same function, and the term “first,” “second,” “third,” “fourth,” “fifth,” or “sixth” will only be used when a specific one of the positioning device 21-26 is to be referred to in the relevant context. In addition, it should be noted herein that while the positioning devices 21-26 include the same components as disclosed in FIG. 3, this does not mean that implementations of the positioning devices 21-26 need to be identical in practice, i.e., they may differ from each other in size, appearance, or model number, etc., as long as the functionalities and purposes served thereby as discussed below are satisfied. For example, in some embodiments, the third and the fourth positioning devices 23 and 24 may each be integrated into a handheld controller for playing video games.

The optical sensor 201 is configured to detect the 2D scanning signals emitted by the signal emitting devices 11 and 12 so as to generate a detection result. The IMU 202 of each of the positioning devices 21-26 is configured to measure angular velocity of the positioning device 21-26. The communication unit 204 supports short-range wireless communication standards. The positioning controller 203 of each of the positioning devices 21-26 is configured to determine angular information of an orientation of the positioning device 21-26 based on the angular velocity measured by the IMU 202 of the same positioning device 21-26, and to determine spatial coordinates of a position of the positioning device 21-26 based on the detection result generated by the optical sensor 201 of the same positioning device 21-26. In this way, each of the positioning devices 21-26 may be utilized to trace a position and angular information of an orientation of an object (e.g., the head, the waist, the left hand, the right hand, the left foot or the right foot of the user) on which the positioning device 21-26 is located.

The display device 4 may be a liquid-crystal display (LCD), a light-emitting diode (LED) display, a plasma display panel or the like. However, implementation of the display device 4 is not limited to the disclosure herein and may vary in other embodiments.

The processor 3 is electrically connected to the display device 4. In addition, the processor 3 supports the short-range wireless communication standards, and is configured to establish connection with each of the positioning devices 21-26 based on wireless communication techniques. In one embodiment, the processor 3 and the display device 4 are separate objects such as a personal computer and a television. In one embodiment, the processor 3 and the display device 4 are integrated into a single object such as a notebook computer, a smartphone and the like. It is worth to note that the processor 3 has a machine learning model and a position estimating model stored therein in advance.

In this embodiment, the position estimating model is formulated with inverse kinematics, and is established based on triangulation and limitations conforming with principles of ergonomics, which should be readily apparent to those skilled in the art and thus details of the same are omitted herein for the sake of brevity.

In this embodiment, the machine learning model is established by training an artificial neural network by using plural pieces of position training data and plural pieces of skeleton training data as input data to the artificial neural network. In this embodiment, the artificial neural network is a recurrent neural network (RNN). The pieces of position training data and the pieces of skeleton training data are derived from a training data set that is generated by a plurality of optical sensors worn by a plurality of testers who have different builds or bone structures or who are of different body types and who performed preset actions. In this embodiment, each of the testers wore fifty optical sensors, but the number of the optical sensors worn by each tester is not limited thereto. Each of the pieces of position training data contains spatial coordinates of positions of the head, the waist, the left hand, the right hand, the left foot and the right foot of one of the testers who is performing one of the preset actions for training the artificial neural network. Each of the pieces of skeleton training data corresponds to a skeleton that is related to the respective one of the testers who performed one of the preset actions for training the artificial neural network, and contains data of features of the skeleton related to the respective tester. As used herein, a “skeleton” means a basic skeletal construction that is used to represent a body frame of a respective tester or user.

It should be noted that in this embodiment, for each of the pieces of position training data used in establishing the machine learning model, based on the spatial coordinates contained in the piece of position training data of the positions of the head, the waist, the left hand, the right hand, the left foot and the right foot of the corresponding one of the testers, the artificial neural network (i.e., the RNN) outputs not only the spatial coordinates of the positions of the head, the waist, the left hand, the right hand, the left foot and the right foot of the tester which have served as the input data to the RNN, but also spatial coordinates of positions of other body portions of the tester, such as the neck, the left shoulder, the right shoulder, the left elbow, the right elbow, the left knee, the right knee or the like. The spatial coordinates of the positions of the head, the waist, the left hand, the right hand, the left foot and the right foot together with the spatial coordinates of the positions of the aforementioned other body portions constitute estimated position data (i.e., output data of the RNN). Thereafter, a loss function is utilized to calculate feature differences between features of a skeleton that is generated based on the estimated position data and the data of the features of the skeleton that is related to the tester and that is contained in one of the pieces of the skeleton training data that corresponds to the tester. The features used in calculating the feature differences may be a distance between two joints (i.e., a bone length) in each of the skeletons, and a linear/angular acceleration, a linear/angular velocity, an angle of rotation and the spatial coordinates of positions of joints/body portions. Then, the feature differences thus calculated are fed back to the artificial neural network for updating relevant coefficients of the machine learning model. However, implementation of the machine learning model is not limited to the disclosure herein and may vary in other embodiments.

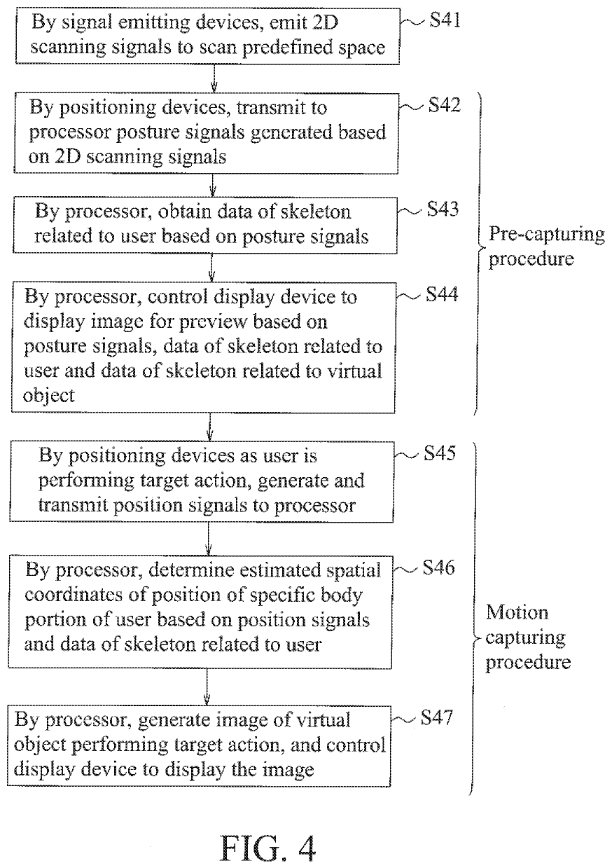

Referring to FIG. 4, the method of motion capture according to the disclosure includes steps S41 to S47 disclosed below.

In step S41, one of the signal emitting devices 11 and 12 emits a 2D scanning signal along a predetermined direction (e.g., along a vertical direction) to scan the predefined space, and another of the signal emitting devices 11 and 12 emits another 2D scanning signal along another predetermined direction (e.g., along a horizontal direction) to scan the predefined space. It is worth to note that spatial scan rates of the signal emitting devices 11 and 12 are high enough so that each of the positioning devices 21-26 is able to receive the 2D scanning signals emitted thereby substantially anytime and anywhere in the predefined space.

In step S42, based on the 2D scanning signals received from the signal emitting devices 11 and 12 when the user maintains a preset posture in the predefined space, each of the positioning devices 21-26 generates a posture signal that contains detected spatial coordinates of a current position of the positioning device 21-26. Subsequently, each of the positioning devices 21-26 transmits the posture signal generated thereby to the processor 3 based on the wireless communication techniques. In this embodiment, the preset posture is a T-pose as shown in FIG. 5. It should be noted that the detected spatial coordinates of the current position of each of the first to the sixth positioning devices 21 to 26 may be regarded as detected spatial coordinates of a respective one of positions of the head, the waist, the left hand, the right hand, the left foot and the right foot of the user.

In step S43, the processor 3 obtains data of a skeleton related to the user based on the first to the sixth posture signals. Specifically speaking, the processor 3 calculates presumed spatial coordinates of a position of the neck of the user based on the first, the third and the fourth posture signals respectively transmitted by the first, the third and the fourth positioning devices 21, 23 and 24. Additionally, the processor 3 determines lengths of two lower arms and two upper arms, and a width between two shoulders of the user based on the presumed spatial coordinates of the position of the neck, the detected spatial coordinates of the positions of the left hand and the right hand, and a first predetermined proportional relationship that is related to the neck, the shoulders, the elbows and the hands. Moreover, the processor 3 determines lengths of two thighs and two lower legs of the user based on the presumed spatial coordinates of the position of the neck, the detected spatial coordinates of the positions of the waist, the left foot and the right foot, and a second predetermined proportional relationship that is related to the waist, the knees and the feet. It should be noted that the length of the thigh is a distance between the pelvis and the knee, and a position of the pelvis may be estimated based on the detected spatial coordinates of the position of the waist and the presumed spatial coordinates of the position of the neck. Consequently, the data of the skeleton that is related to the user and that contains the lengths of the lower arms, the upper arms, the thighs and the lower legs, and the width of the shoulders of the user is obtained. Moreover, body proportions related to the user can be calculated according to the aforementioned lengths and width, and are further included in the data of the skeleton related to the user.

In step S44, the processor 3 generates an image for preview based on the first to the sixth posture signals, the data of the skeleton related to the user obtained in step S43, and data of a skeleton related to the virtual object. As shown in FIG. 5, in this embodiment, the image for preview contains the virtual object assuming the preset posture (i.e., the T-pose) 51, the skeleton related to the user 52 and the skeleton related to the virtual object 53. Then, the processor 3 controls the display device 4 to display the image for preview. In one embodiment, the processor 3 determines a ground plane in the image for preview based on the fifth and the sixth posture signals which are respectively transmitted by the fifth and the sixth positioning devices 25 and 26 and which respectively contain the detected spatial coordinates of positions of the left foot and the right foot.

It is worth to note that steps S42 to S44 constitute a pre-capturing procedure, which aims to obtain the data of the skeleton related to the user when the method of motion capture is first performed on the user.

In step S45, as the user is performing a target action, for each sampling instant during the performance of the target action by the user, the optical sensor 201 of each of the positioning devices 21-26 receives the 2D scanning signals emitted from the signal emitting devices 11 and 12 so as to obtain the detected spatial coordinates of a current position of the positioning device 21-26, and transmits the same to the positioning controller 203 of the positioning device 21-26. At the same time, the IMU 202 of each of the positioning devices 21-26 determines the angular information of the orientation of the positioning device 21-26, and transmits the same to the positioning controller 203 of the positioning device 21-26 as well. Subsequently, the positioning controller 203 of each of the positioning devices 21-26 generates a position signal that contains the angular information of the orientation of the positioning device 21-26, and that contains the detected spatial coordinates of the current position of the positioning device 21-26. Herein, the position signals generated by the first to the sixth positioning devices 21 to 26 are also termed “first to sixth position signals,” respectively. Thereafter, for each of the positioning devices 21-26, the positioning controller 203 transmits the respective position signal via the communication unit 204 of the positioning device 21-26 to the processor 3 based on the wireless communication techniques. That is to say, the detected spatial coordinates of the positions of the head, the waist, the left hand, the right hand, the left foot and the right foot of the user, and the angular information of the orientation of the head, the waist, the left hand, the right hand, the left foot and the right foot of the user are provided to the processor 3 by the first to the sixth positioning devices 21 to 26 located respectively on the head, the waist, the left hand, the right hand, the left foot and the right foot of the user by the first to the sixth position signals.

In step S46, based on the first to the sixth position signals respectively received from the first to the sixth positioning devices 21 to 26 and based on the data of the skeleton related to the user obtained in step S43, the processor 3 determines estimated spatial coordinates of a current position, at the sampling instant, of a specific body portion of the user other than the head, the waist, the left hand, the right hand, the left foot and the right foot of the user by using a position estimating model that matches the skeleton related to the user. In this embodiment, such specific body portion of the user is plural in number, and the specific body portions at least include the neck, the left shoulder, the right shoulder, the left elbow, the right elbow, the left knee and the right knee of the user. In other embodiments, the body portions of the user further include a plurality of parts of the spine of the user. It is noted that the position estimating model stored in the processor 3 needs to be calibrated first based on the data of the skeleton related to the user so as to obtain the position estimating model that matches the skeleton related to the user.

In one embodiment, to enhance performance of the method of motion capture according to the disclosure, the processor 3 determines the estimated spatial coordinates of the current positions of the specific body portions of the user by using the machine learning model based on the first to the sixth position signals received from the first to the sixth positioning devices 21 to 26 and based on the data of the skeleton related to the user. That is to say, the first to the sixth position signals and the data of the skeleton related to the user are used as input data to the machine learning model, and the machine learning model calculates and outputs the estimated spatial coordinates of the current positions of the specific body portions of the user as output data. Furthermore, in this embodiment, the specific body portions of the user include the parts of the spine, the neck, the left and right shoulders, the left and right elbows, and the left and right knees.

In step S47, the processor 3 generates an image of the virtual object at the sampling instant during performance of the target action based on the first to the sixth position signals, the estimated spatial coordinates, the data of the skeleton related to the user, and the data of the skeleton related to the virtual object. The processor 3 then controls the display device 4 to display the image of the virtual object performing the target action. It is worth to note that repeated performance of steps S45 to S47 in the method of motion capture according to the disclosure by the system 100 at multiple sampling instants enables the processor 3 to generate an animation of the virtual object performing the target action as the user is performing the target action in the predefined space. The virtual object may be made to follow other actions performed by the user in the predefined space based on the same principles. Steps S45 to S47 constitute a motion capturing procedure.

In summary, the method of motion capture according to the disclosure utilizes the positioning devices 21-26, which are located on the head, the waist, the hands and the feet of the user who is performing a target action, to receive the scanning signals emitted by the signal emitting devices 11 and 12 in order to obtain the detected spatial coordinates of the positions of the aforementioned body parts of the user other than the head, the waist, the hands and the feet of the user, to determine the angular information, and to generate and transmit to the processor 3 the first to the sixth position signals that contain the angular information and the detected spatial coordinates. Based on the first to the sixth position signals and the data of the skeleton related to the user, the processor 3 determines the estimated coordinates of the positions of such specific body portions (e.g., the neck, the shoulders, the elbows and the knees) of the user by using one of the machine learning model and the position estimation model that are established in advance. Then, the processor 3 generates the image of the virtual object performing the target action based on the first to the sixth position signals, the estimated coordinates, the data of the skeleton related to the user, and the data of the skeleton related to the virtual object, and controls the display device 4 to display the image. Compared with conventional methods of motion capture, the method of motion capture according to the disclosure does not require high-resolution image capturing devices, a large number of markers, and special software for processing collected image data, so costs of hardware and software are reduced. In addition, the number of body parts of the user to be traced is reduced, so an amount of collected data to be processed may decrease, thereby reducing the loading on data processing.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method of motion capture adapted to record a posture of a user in a predefined space and translating the posture to a virtual object, the method to be implemented by a system that includes a processor, a display device, two signal emitting devices located at respective predetermined positions, and six positioning devices respectively located on a head, a waist, a left hand, a right hand, a left foot and a right foot of the user, said method comprising:
(A) emitting, by one of the signal emitting devices, a two-dimensional (2D) scanning signal along a predetermined direction to scan the predefined space, and emitting, by another of the signal emitting devices, another 2D scanning signal along another predetermined direction to scan the predefined space;
(B) by each of the positioning devices at an instant during performance of a target action by the user, receiving the 2D scanning signals emitted from the signal emitting devices so as to obtain detected spatial coordinates of a current position of the positioning device, determining angular information of an orientation of the positioning device, generating a position signal that contains the angular information of the orientation of the positioning device, and that contains the detected spatial coordinates of the current position of the positioning device, and transmitting the position signal to the processor based on wireless communication techniques;
(C) determining, by the processor based on the position signals respectively received from the positioning devices and based on data of a skeleton related to the user, estimated spatial coordinates of a current position of a specific body portion of the user by using one of a machine learning model and a position estimating model that matches the skeleton related to the user; and
(D) by the processor, generating an image of the virtual object at the instant during performance of the target action based on the position signals, the estimated spatial coordinates, the data of the skeleton related to the user, and data of a skeleton related to the virtual object, and controlling the display device to display the image of the virtual object at the instant during performance of the target action.

2. The method of motion capture as claimed in claim 1, prior to step (B), further comprising:
(E) by each of the positioning devices, generating a posture signal that contains the detected spatial coordinates of a current position of the positioning device based on the 2D scanning signals received from the signal emitting devices when the user maintains a preset posture in the predefined space, and transmitting the posture signal to the processor based on the wireless communication techniques;
(F) by the processor based on the posture signals generated respectively by the positioning devices, obtaining the data of the skeleton related to the user; and
(G) by the processor, generating an image for preview based on the posture signals, the data of the skeleton related to the user and the data of the skeleton related to the virtual object, and controlling the display device to display the image for preview, wherein the image for preview contains the virtual object assuming the preset posture, the skeleton related to the user and the skeleton related to the virtual object.

3. The method of motion capture as claimed in claim 1, wherein in step (C), the specific body portion of the user is plural in number, and the specific body portions at least include a neck, a left shoulder, a right shoulder, a left elbow, a right elbow, a left knee and a right knee.

4. The method of motion capture as claimed in claim 3, wherein in step (C):
the position estimating model is established based on triangulation and limitations conforming with principles of ergonomics; and
the machine learning model is established by training an artificial neural network with plural pieces of position training data and plural pieces of skeleton training data, the pieces of position training data and the pieces of skeleton training data being derived from a training data set that is generated by a plurality of optical sensors worn by a plurality of testers having different body types and performing preset actions, each of the pieces of position training data containing spatial coordinates of positions of a head, a waist, a left hand, a right hand, a left foot and a right foot of one of the testers who is performing one of the preset actions for training the artificial neural network, each of the pieces of skeleton training data containing data of the skeleton related to a respective one of the testers who is performing one of the preset actions for training the artificial neural network.

5. The method of motion capture as claimed in claim 1, wherein the artificial neural network is a recurrent neural network (RNN).
